(19) United States
(12) Patent Application Publication
(10) Pub. No.: US 2015/0108958 A1
(43) Pub. Date: Apr. 23, 2015

(54) HYBRID THREE-LEVEL T-TYPE CONVERTER FOR POWER APPLICATIONS

(71) Applicant: Eaton Corporation, Cleveland, OH (US)

(72) Inventors: Jun Xu, Shanghai (CN); Yu Liu, Katy, TX (US); Yilei Gu, Shenzhen (CN)

(73) Assignee: Eaton Corporation, Cleveland, OH (US)

(21) Appl. No.: 14/060,197

(22) Filed: Oct. 22, 2013

(51) Int. Cl. H02M 3/155

(52) U.S. Cl. CPC H02M 3/155
USPC 323/282

(57) ABSTRACT

Three-level T-type power converters include a totem-pole arrangement of first and second wide bandgap field effect transistors, which are electrically connected in common at an output node of the converter. A pair of power transistors is provided along with a totem-pole arrangement of first and second capacitors. The power transistors are electrically connected in an opposing series relationship between the output node and a reference node. The first and second capacitors are electrically connected in common at the reference node. The first capacitor has a first terminal electrically connected to a first terminal of the first wide bandgap field effect transistor and the second capacitor has a second terminal electrically connected to a second terminal of the second wide bandgap field effect transistor.

### CROSS-REFERENCE TO RELATED APPLICATION

This application is related to U.S. application Ser. No. 13/729,943, filed Dec. 28, 2012, entitled “Hybrid Power Devices and Switching Circuits for High Power Load Sourcing Applications,” the disclosure of which is hereby incorporated herein by reference.

### FIELD OF THE INVENTION

The present invention relates to integrated circuit devices and, more particularly, to integrated circuit devices for power switching applications.

### BACKGROUND OF THE INVENTION

Wide bandgap (WBG) power devices such as SiC and GaN power devices can provide superior performance characteristics relative to Si power devices for many high power applications. For example, as disclosed in an article by J. Burm et al., entitled “Wide Band-Gap FETs for High Power Amplifiers,” Journal of Semiconductor Technology and Science, Vol. 6, No. 3, pp. 175-182, September (2006), wide bandgap semiconductor materials having band-gap energy levels in a range from about 2 eV to about 6eV may be utilized to provide high breakdown voltages for high power generation in power amplifiers and low dielectric constants for better isolation and lower coupling. Similarly, as disclosed in an article by J. Reed et al., entitled “Modeling Power Semiconductor Losses in HEV Powertrains using Si and SiC Devices,” Vehicle Power and Propulsion Conference (VPPC), 2010 IEEE, Sep. 1-3 (2010), silicon carbide (SiC) power devices were shown to have potential benefits over conventional silicon-based devices, particularly in high power electronic converters.

Examples of high power switches that embody wide bandgap semiconductors are disclosed in U.S. Pat. Nos. 7,556,994 and 7,820,511 to Sankin et al., which illustrates normally-off vertical JFET integrated power switches, U.S. Pat. No. 7,230,273 to Kitabatake et al., which describes a plurality of wide bandgap switching elements connected in parallel to increase device yield, and U.S. Pat. No. 8,017,978 to Lidow et al., which illustrates multiple power devices of different type connected in series. Still further examples of wide bandgap JFET power switches are disclosed in an article by G. Deboy et al., entitled “New SiC JFET Boost Performance of Solar Inverters,” Power Electronics Europe, Issue 4, pp. 29-33, www.power-mag.com (2011); and in an article by A. I. Maswood, entitled “Silicon Carbide Based Inverters for Energy Efficiency,” IEEE Transportation Electrification Conference and Expo (ITEC), Jun. 18-20, 2012, pp. 1-5.

### SUMMARY OF THE INVENTION

Three-level T-type power converters according to embodiments of the invention utilize a hybrid combination of high power switches. According to some of these embodiments of the invention, a T-type power converter includes a totem-pole arrangement of first and second wide bandgap field effect transistors, which are electrically connected in common at an output node of the converter. A pair of power transistors is also provided along with a totem-pole arrangement of first and second capacitors. The power transistors are electrically connected in an opposing series relationship between the output node and a reference node. The first and second capacitors are electrically connected in common at the reference node. The first capacitor has a first terminal electrically connected to a first terminal of the first wide bandgap field effect transistor and the second capacitor has a second terminal electrically connected to a second terminal of the second wide bandgap field effect transistor.

In some additional embodiments of the invention, the pair of power transistors is selected from a group consisting of silicon MOS transistors (e.g., MOSFETs) and gallium nitride (GaN) high electron mobility transistors (HEMTs). The first and second wide bandgap field effect transistors can be selected from a group consisting of silicon carbide JFETs and silicon carbide MOSFETs. A second terminal of the first wide bandgap field effect transistor can be electrically connected to a first terminal of the second wide bandgap field effect transistor at the output node.

In still further embodiments of the invention, the pair of power transistors may include a pair of silicon MOSFETs having commonly connected source terminals. In addition, a pair of diodes can be provided, which are electrically connected in an opposing series relationship between the output node and the reference node. The anode terminals of the pair of diodes are electrically connected together and to the source terminals of the pair of silicon MOSFETs. In some embodiments of the invention, the diodes may be configured as the body diodes of the MOSFETs. Alternatively, the pair of power transistors can be pair of gallium nitride high electron mobility transistors having commonly connected drain terminals.

According to still further embodiments of the invention, a hybrid three-level T-type power converter includes a totem-pole arrangement of first and second silicon carbide field effect transistors, which are electrically connected in common at an output node of the converter. The converter also includes a totem-pole arrangement of first and second capacitors electrically connected in common at a first node. The first capacitor has a first terminal electrically connected to a first current carrying terminal of the first silicon carbide field effect transistor and the second capacitor has a second terminal electrically connected to a second current carrying terminal of the second wide bandgap field effect transistor. First and second gallium nitride high electron mobility transistors are also provided. These transistors have commonly connected drain terminals. The first gallium nitride high electron mobility transistor has a source terminal electrically coupled to the first node and the second gallium nitride high electron mobility transistor has a source terminal electrically coupled to the output node. Moreover, the second current carrying terminal of the first silicon carbide field effect transistor is electrically connected to a first current carrying terminal of the second silicon carbide field effect transistor at the output node.

According to an additional embodiment of the invention, a hybrid three-level T-type power converter is provided with a totem-pole arrangement of first and second silicon carbide field effect transistors that are electrically connected in common at an output node of the converter. A totem-pole arrangement of first and second capacitors is provided. The first and second capacitors are electrically connected in common at a first node. The first capacitor has a first terminal electrically connected to a first current carrying terminal of the first silicon carbide field effect transistor and the second capacitor has a second terminal electrically connected to a second current carrying terminal of the second silicon carbide field effect transistor. First and second silicon MOSFETs are also provided with commonly connected source terminals. The first silicon MOSFET has a drain terminal electrically coupled to the first node and the second silicon MOSFET has a drain terminal electrically coupled to the output node. A pair of diodes may be provided, which are electrically connected in an opposing series relationship between the output node and the first node. The anode terminals of the pair of diodes are electrically connected together and to the source terminals of the first and second silicon MOSFETs.

### BRIEF DESCRIPTION OF THE DRAWINGS

FIG. 1A is an electrical schematic of a hybrid three-level T-type power converter with silicon carbide (SiC) and silicon (Si) MOSFETs, according to an embodiment of the invention.

FIG. 1B is an electrical schematic of a hybrid three-level T-type power converter with silicon carbide (SiC) JFETs and silicon (Si) MOSFETs, according to an embodiment of the invention.

FIG. 2A is an electrical schematic of a hybrid three-level T-type power converter with silicon carbide (SiC) JFETs and gallium nitride (GaN) high electron mobility transistors (HEMTs), according to an embodiment of the invention.

FIG. 2B is an electrical schematic of a hybrid three-level T-type power converter with silicon carbide (SiC) MOSFETs and gallium nitride (GaN) high electron mobility transistors (HEMTs), according to an embodiment of the invention.

### DETAILED DESCRIPTION OF EMBODIMENTS

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer (and variants thereof), it can be directly on, connected or coupled to the other element or layer or intervening elements or layers may be present. In contrast, when an element is referred to as being “directly on,” “directly connected to” or “directly coupled to” another element or layer (and variants thereof), there are no intervening elements or layers present. Like reference numerals refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprising”, “including”, “having” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements and/or components.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

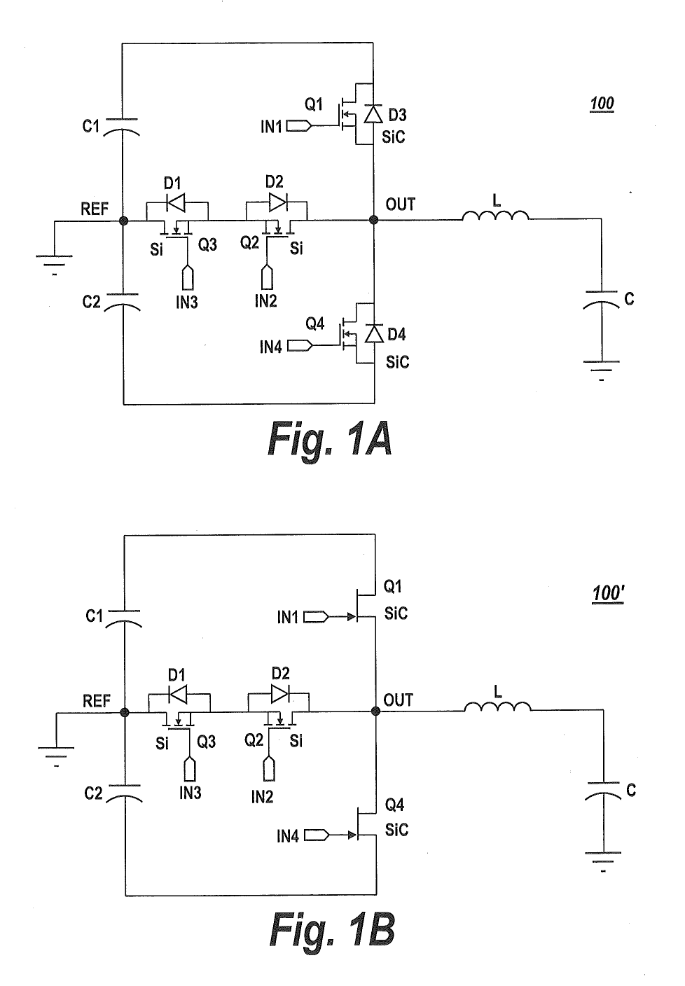

Referring now to FIG. 1A, a hybrid three-level T-type power converter 100 according to an embodiment of the invention is illustrated as including a pair of silicon carbide (SiC) MOSFETs (Q1, Q4), a pair of silicon (Si) MOSFETs (Q2, Q3), a pair of capacitors C1, C2 and diodes D1, D2, D3 and D4 (e.g., MOSFET body diodes) connected as illustrated to drive a load (e.g., series LC circuit). The converter 100 is shown as including a hybrid combination of high power switches, which are responsive to respective input control signals IN1-IN4. This hybrid combination of high power switches includes a totem-pole arrangement of first and second SiC MOSFETs Q1, Q4, which are electrically connected in common at an output node (OUT) of the converter 100. A pair of silicon power MOSFETs Q2, Q3 is also provided along with a totem-pole arrangement of first and second capacitors C1 and C2, which are connected together at a reference node REF (e.g., GND). As shown, the power MOSFETs Q2, Q3 are electrically connected in an opposing series relationship (e.g., source-to-source) between the output node OUT and the reference node REF. Based on the illustrated totem pole arrangement, the first capacitor C1 has a first terminal electrically connected to a first current carrying terminal (e.g., drain) of the first SiC MOSFET Q1 and the second capacitor C2 has a second terminal electrically connected to a second current carrying terminal (e.g., source) of the second SiC MOSFET Q4. A second current carrying terminal (e.g., source) of the first SiC MOSFET Q1 is electrically connected to a first current carrying terminal (e.g., drain) of the second SiC MOSFET Q4 at the output node OUT. The pair of diodes D1, D2, which are electrically connected in an opposing series relationship between the output node OUT and the reference node REF. As shown, the anode terminals of the diodes D1, D2 are electrically connected together and to the source terminals of the pair of silicon MOSFETs Q2, Q3.

Referring now to FIG. 1B, a hybrid three-level T-type power converter 100′ according to an additional embodiment of the invention is illustrated as including a pair of silicon carbide (SiC) JFETs (Q1, Q4), a pair of silicon (Si) MOSFETs (Q2, Q3), a pair of capacitors C1, C2 and a pair of diodes D1, D2, connected as illustrated and responsive to respective input control signals IN1-IN4. This converter 100′ includes a totem-pole arrangement of first and second SiC JFETs, which are electrically connected in common at an output node (OUT) of the converter 100′. A pair of silicon power MOSFETs Q2, Q3 is also provided along with a totem-pole arrangement of first and second capacitors C1 and C2, which are connected together at a reference node REF (e.g., GND). As shown, the power MOSFETs Q2, Q3 are electrically connected in an opposing series relationship (e.g., source-to-source) between the output node OUT and the reference node REF. Based on the illustrated totem pole arrangement, the first capacitor C1 has a first terminal electrically connected to a first current carrying terminal (e.g., drain) of the first SiC JFET Q1 and the second capacitor C2 has a second terminal electrically connected to a second current carrying terminal (e.g., source) of the second SiC JFET Q4. A second current carrying terminal (e.g., source) of the first SiC JFET Q1 is electrically connected to a first current carrying terminal (e.g., drain) of the second SiC JFET Q4 at the output node OUT. The pair of diodes D1, D2 are electrically connected in an opposing series relationship between the output node OUT and the reference node REF. The anode terminals of the diodes D1, D2 are electrically connected together and to the source terminals of the pair of silicon MOSFETs Q2, Q3, as illustrated. As will be understood by those skilled in the art, the diodes D1 and D2 may be configured as the body diodes of the silicon MOSFETs Q2 and Q3.

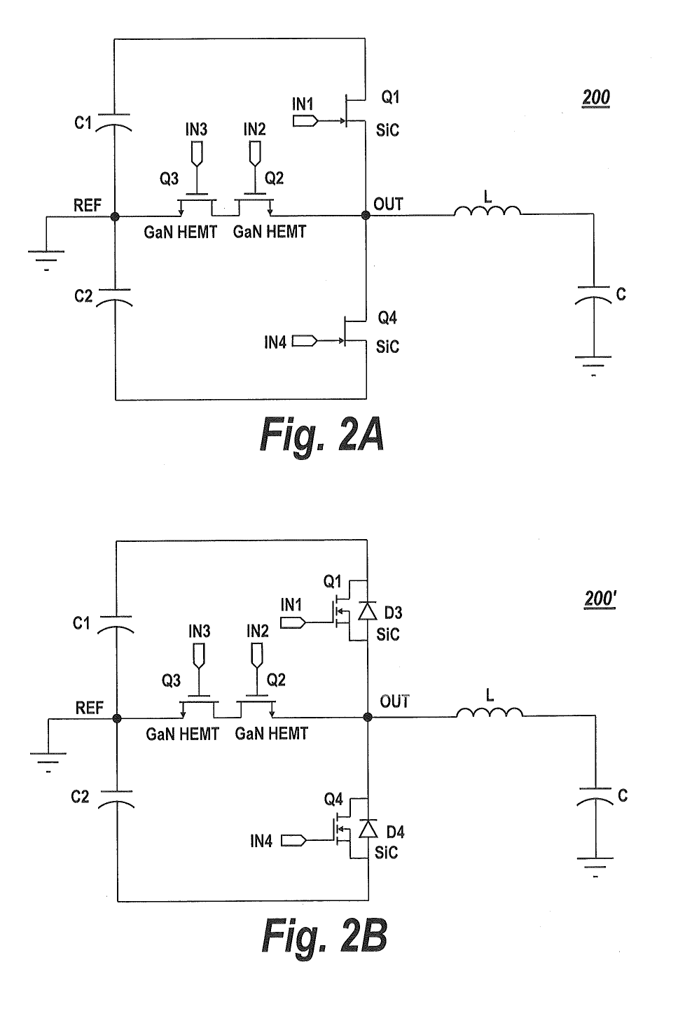

Referring now to FIG. 2A, a hybrid three-level T-type power converter 200 according to an additional embodiment of the invention is illustrated as including a pair of silicon carbide (SiC) JFETs (Q1, Q4), a pair of gallium nitride (GaN) HEMTs (Q2, Q3) and a pair of capacitors C1, C2, connected as illustrated and responsive to respective input control signals IN1-IN4. This converter 200 includes a totem-pole arrangement of first and second SiC JFETs, which are electrically connected in common at an output node (OUT) of the converter 200. A pair of GaN HEMTs Q2, Q3 is also provided along with a totem-pole arrangement of first and second capacitors C1 and C2, which are connected together at a reference node REF (e.g., GND). As shown, the high electron mobility transistors Q2, Q3 are electrically connected in an opposing series relationship (e.g., drain-to-drain) between the output node OUT and the reference node REF. Based on the illustrated totem pole arrangement, the first capacitor C1 has a first terminal electrically connected to a first current carrying terminal (e.g., drain) of the first SiC JFET Q1 and the second capacitor C2 has a second terminal electrically connected to a second current carrying terminal (e.g., source) of the second SiC JFET Q4. A second current carrying terminal (e.g., source) of the first SiC JFET Q1 is electrically connected to a first current carrying terminal (e.g., drain) of the second SiC JFET Q4 at the output node OUT.

Referring now to FIG. 2B, a hybrid three-level T-type power converter 200′ according to an additional embodiment of the invention is illustrated as including a pair of silicon carbide (SiC) MOSFETs (Q1, Q4) (and diodes D3, D4 (e.g., body diodes)), a pair of gallium nitride (GaN) HEMTs (Q2, Q3) and a pair of capacitors C1, C2, connected as illustrated and responsive to respective input control signals IN1-IN4. This converter 200′ includes a totem-pole arrangement of first and second SiC MOSFETs, which are electrically connected in common at an output node (OUT) of the converter 200′. A pair of GaN HEMTs Q2, Q3 is provided along with a totem-pole arrangement of first and second capacitors C1 and C2, which are connected together at a reference node REF (e.g., GND). As shown, the high electron mobility transistors Q2, Q3 are electrically connected in an opposing series relationship (e.g., drain-to-drain) between the output node OUT and the reference node REF. Based on the illustrated totem pole arrangement, the first capacitor C1 has a first terminal electrically connected to a first current carrying terminal (e.g., drain) of the first SiC MOSFET Q1 and the second capacitor C2 has a second terminal electrically connected to a second current carrying terminal (e.g., source) of the second SiC MOSFET Q4. A second current carrying terminal (e.g., source) of the first SiC MOSFET Q1 is electrically connected to a first current carrying terminal (e.g., drain) of the second SiC MOSFET Q4 at the output node OUT.

Thus, as described above with respect to FIGS. 1A-1B and 2A-2B, a three-level T-type power converter may utilize silicon carbide JFETs and MOSFETs to achieve higher efficiency (e.g., at 20 kHz) relative to converters containing IGBT devices. This higher efficiency can be further enhanced by using gallium nitride high electron mobility transistors (HEMTs), which have much lower switching losses relative to silicon carbide devices.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A hybrid three-level T-type power converter, comprising:
a totem-pole arrangement of first and second wide bandgap field effect transistors electrically connected in common at an output node of the converter;
a pair of power transistors electrically connected in an opposing series relationship between the output node and a reference node; and
a totem-pole arrangement of first and second capacitors electrically connected in common at the reference node, said first capacitor having a first terminal electrically connected to a first terminal of the first wide bandgap field effect transistor and said second capacitor having a second terminal electrically connected to a second terminal of the second wide bandgap field effect transistor.

2. The converter of claim 1, wherein the pair of power transistors is selected from a group consisting of silicon MOS transistors and gallium nitride high electron mobility transistors.

3. The converter of claim 2, wherein the first and second wide bandgap field effect transistors are selected from a group consisting of silicon carbide JFETs and silicon carbide MOSFETs.

4. The converter of claim 2, wherein a second terminal of the first wide bandgap field effect transistor is electrically connected to a first terminal of the second wide bandgap field effect transistor at the output node.

5. The converter of claim 3, wherein a second terminal of the first wide bandgap field effect transistor is electrically connected to a first terminal of the second wide bandgap field effect transistor at the output node.

6. The converter of claim 1, wherein the pair of power transistors comprises a pair of silicon MOSFETs having commonly connected source terminals.

7. The converter of claim 6, further comprising a pair of diodes electrically connected in an opposing series relationship between the output node and the reference node.

8. The converter of claim 7, wherein anode terminals of the pair of diodes are electrically connected together and to the source terminals of the pair of silicon MOSFETs.

9. The converter of claim 1, wherein the pair of power transistors comprises a pair of gallium nitride high electron mobility transistors having commonly connected drain terminals.

10. A hybrid three-level T-type power converter, comprising:
a totem-pole arrangement of first and second silicon carbide field effect transistors electrically connected in common at an output node of the converter;
a totem-pole arrangement of first and second capacitors electrically connected in common at a first node, said first capacitor having a first terminal electrically connected to a first current carrying terminal of the first silicon carbide field effect transistor and said second capacitor having a second terminal electrically connected to a second current carrying terminal of the second wide bandgap field effect transistor; and
first and second gallium nitride high electron mobility transistors having commonly connected drain terminals, said first gallium nitride high electron mobility transistor having a source terminal electrically coupled to the first node and said second gallium nitride high electron mobility transistor having a source terminal electrically coupled to the output node.

11. The converter of claim 10, wherein the first and second silicon carbide field effect transistors are silicon carbide junction field effect transistors or silicon carbide MOSFETs.

12. The converter of claim 11, wherein a second current carrying terminal of the first silicon carbide field effect transistor is electrically connected to a first current carrying terminal of the second silicon carbide field effect transistor at the output node.

13. A hybrid three-level T-type power converter, comprising:
a totem-pole arrangement of first and second silicon carbide field effect transistors electrically connected in common at an output node of the converter;
a totem-pole arrangement of first and second capacitors electrically connected in common at a first node, said first capacitor having a first terminal electrically connected to a first current carrying terminal of the first silicon carbide field effect transistor and said second capacitor having a second terminal electrically connected to a second current carrying terminal of the second silicon carbide field effect transistor; and
first and second silicon MOSFETs having commonly connected source terminals, said first silicon MOSFET having a drain terminal electrically coupled to the first node and said second silicon MOSFET having a drain terminal electrically coupled to the output node.

14. The converter of claim 13, further comprising a pair of diodes electrically connected in an opposing series relationship between the output node and the first node.

15. The converter of claim 14, wherein anode terminals of the pair of diodes are electrically connected together and to the source terminals of said first and second silicon MOSFETs.
